(19) United States
(12) Patent Application Publication
(10) Pub. No.: US 2002/0041221 A1
(43) Pub. Date: Apr. 11, 2002

(54) Tunable bandpass filter

(76) Inventor: Jawad Abdulnour, Pierrefonds (CA)

Correspondence Address: BORDEN LADNER GERVAIS, LLP, 1000 - 60 QUEEN STREET, OTTAWA, ON, K1P 5Y7, CA

(21) Appl. No.: 09/904,481

(22) Filed: Jul. 16, 2001

(30) Foreign Application Priority Data
Jul. 17, 2000 (CA) 2,313,925

(51) Int. Cl. H01P 1/20

(52) U.S. Cl. 333/202; 333/235

(57) ABSTRACT

A method and apparatus for reducing the size of microwave (or millimeter wave) dielectric resonator filters and for tuning the filter by inserting tuning screw within the dielectric itself. The filter includes a metallic housing that encloses a plurality of cavities, and each cavity contains a dielectric resonator whose top and bottom surfaces are flush with the top and bottom walls of the metallic structure. Due to the continuity and uniformity of the electric field generated in the y-axis of the dielectric, the filter's performance response becomes independent of height. This novel design allows for substantial reduction in cavity size without appreciably dropping the Q factor. Such continuity and uniformity of the electric field also allows for openings to be made parallel to the y-axis and inside the dielectric resonator, wherein tuning screws are inserted to selectively adjust the frequency. Other aspects of the invention include alternative methods for electromagnetic coupling in, within, and out of the filter; methods for reducing the machining accuracy by creating a small air gap at one end of the resonator; and methods for reducing the propagation of high modes by alternating the shapes or orientation of the resonators within the filter.

### FIELD OF THE INVENTION

The present invention relates to microwave filters in wireless telecommunications systems. In particular, the present invention relates to dielectric resonator filters operating in microwave and millimeter wave rectangular waveguides or cavities of transceivers.

### BACKGROUND OF THE INVENTION

Over the years a wide variety of microwave and millimeter wave filters have been developed, each satisfying specific application requirements but none offering the optimum combination of low insertion loss, higher order mode rejection, high unloaded Q factor, high temperature stability, reduced filter size, tunability, and ease of manufacturing.

The first-generation filters consisted of empty cascaded conductive cavities connected together and separated by metallic walls with iris-controlled couplings. These filters are bulky and not particularly suitable for use at low frequencies such as those below the X-band. One solution to this problem was the construction of a coaxial structure supporting a TEM mode with a capacitive gap called a comb-line, as described in G. L. Matthaei, “Comb-line Bandpass Filters of Narrow or Moderate Bandwidth”, Microwave Journal, Vol. 6, August 1963. While this technology offers a greater reduction in size compared to the size of empty rectangular or cylindrical cavities, its moderate Q factor does not meet the stringent Q factor specifications required in certain modern telecommunication systems.

To obtain a high Q factor, the filter configurations most commonly used in today's telecommunication systems consist of a dielectric puck mounted inside a conductive housing without touching the metal conductor, as described in the following references: (a) J. F. Liang and W. D. Blaire, “High Q TE₀₁ Mode DR Filters for PCS Wireless Base Stations”, IEEE Transactions, Microwave Theory Tech., Vol. 1, MTT-46, Dec. 1998; (b) X-P Liang and K. A. Zaki, “Modeling of Cylindrical Dielectric Resonators in Rectangular Waveguides and Cavities”, IEEE Trans. Microwave Theory Tech., Vol. MTT-41, Dec. 1993: and (c) U.S. Pat. No. 5,777,534 to Harrison et al., entitled “Inductor Ring for Providing Tuning and Coupling in Microwave Dielectric Resonator Filters”. In these structures the electromagnetic field is concentrated inside the puck and vanishes gradually outside. While the relatively wide cavity used in these structures reduces the ohmic loss on the metallic wall and increases the Q factor, it also increases the size and weight of the filter. Moreover, an undesirable electromagnetic mode (called the HE_{mnδ} mode) is excited in such structures. This mode produces spurious responses close to the filter bandwidth, which affects the filter rejection performance.

With the advent of cellular mobile phone systems, new filter technologies using dielectric materials have been developed which yield moderate Q factors and reduced size, such as that described in Kikuo Wakino et al, “Miniaturization Technologies of Dielectric Resonator Filters for Mobile Communications”, IEEE Trans. Microwave Theory Tech., Vol. MTT-42, July 1994. However, the topology of the majority of these technologies involve complex geometry that requires high machining accuracy and increased assembly time.

Other recent technologies have been developed to reduce spurious response. A simple configuration of such schemes has been proposed by A. Abdelmonem, J-F. Liang and K. A. Zaki, “Full-wave Design of Spurious-free DR TE Mode Bandpass Filters”, IEEE Trans. Microwave Theory Tech., Vol. MTT-43, April 1995. While the spurious response in this structure is substantially free, the resonators are not tunable. They also require high machining tolerance and high precision in the selection of the value of the dielectric constant.

An example of a prior art device tuning arrangement for a dielectric resonator filter 40 is illustrated in FIG. 1. The filter 40 includes a metallic disk 42 attached to the upper surface of a housing structure 44 by a screw 46. A dielectric resonator 48 is mounted on a support 50 centrally positioned within a cavity 52 of filter 40. The distance between the top surface of the resonator 48 and the bottom surface of the disk 42 can be varied up and down by rotating the screw 46. The disk 42 interacts with the magnetic field of the resonator 48 causing perturbation of the resonance frequency of the cavity 52. A disadvantage of this Topology is the excitation of undesirable spurious hybrid modes at frequencies that are close to the filter's passband.

It is therefore desirable to provide a substantially smaller-size filter for both microwave and millimeter wave frequency bands that uses internally-tunable dielectric resonators. It is further desirable to provide dielectric resonators that have a high Q factor, are easily manufactured and mounted, and provide substantial improvement in out-of-band hybrid mode rejection performances.

### SUMMARY OF THE INVENTION

It is an object of the present invention to obviate or mitigate at least one disadvantage of prior art bandpass filters. In particular, it is an object of the present invention to provide a dielectric resonator filter, particularly for microwave and millimeter wave applications, that is tunable.

In accordance with a first aspect of the present invention , there is provided a tunable dielectric resonator filter. The tunable dielectric resonator filter consists of an electrically conductive housing defining a cavity, and a dielectric resonator disposed in the cavity. A tuning aperture is formed in the resonator. The aperture is substantially parallel to a direction of an electric field excited within the resonator. A tuning device, such as a rod or screw, received within the tuning aperture. The depth of penetration of the tuning device within the resonator determines a frequency response of the resonator.

Typically, a coupling probe is provided to couple a signal to and from the cavity. The coupling probe excites the cavity in a TE mode, and can be within the cavity or disposed in a coupling aperture provided in the resonator. The filter of the present invention in effectively excited in a LSE mode. The resonator can be provided with an electrically conductive coating, on any of its top, bottom or side surfaces.

By coupling together a series of dielectric resonator filters according to the present invention, a tunable bandpass filter can be formed. Typically, the coupling is achieved by irises. Alternatively, an oscillator can be formed by coupling together a dielectric resonator filter according to the present invention with an oscillating element.

### BRIEF DESCRIPTION OF THE DRAWINGS

Preferred embodiments of the present invention will now be described, by way of example only, with reference to the attached figures wherein:

FIG. 1 is a side view of a prior art filter;

FIG. 2 is a top view of a six-pole, dielectric resonator filter in accordance with the present invention;

FIG. 3 is a cross-sectional view of the dielectric resonator filter shown in FIG. 2;

FIG. 4 is a top view of a filter cavity showing the unloaded and loaded sections of a rectangular resonator;

FIG. 5 is a top view of a filter cavity showing the unloaded and loaded sections of a cylindrical resonator;

FIG. 6 is a cross-sectional view of FIG. 4 or FIG. 5 showing the uniformity of the dielectric resonator geometry in the direction of the electric field;

FIG. 7 is a cross-sectional view of the input/output coupling section of a filter having a shorted coupling rod positioned outside the dielectric resonator in accordance with the present invention;

FIG. 8 is a cross-sectional view of the input/output coupling section of a filter having an open-ended coupling rod positioned outside the dielectric resonator in accordance with the present invention;

FIG. 9 is a cross-sectional view of the input/output coupling section of a filter having an open-ended coupling rod positioned within the dielectric resonator in accordance with the present invention;

FIG. 10 is a cross-sectional view of a filter having two open-ended cross-coupling rods between two non-adjacent dielectric resonators in accordance with the present invention;

FIG. 11 is a perspective view of a dielectric resonator inserted in a rectangular metallic housing in accordance with the present invention;

FIG. 12 is a perspective view of a dielectric resonator inserted in a rectangular metallic housing showing a small air gap between the top of the resonator and the top of the housing;

FIG. 13 is a cross-sectional view of a dielectric resonator inserted in a rectangular metallic housing showing the insertion of an expandable conductor slab in the air gap of FIG. 12;

FIG. 14 is a perspective view of a rectangular dielectric resonator that has been metal-plated on its top and bottom surfaces;

FIG. 15 is a perspective view of a rectangular dielectric resonator that has been metal-plated only on its bottom surface in accordance with another aspect of the present invention.

FIG. 16 is a perspective view of a cylindrical dielectric resonator that has been metal-plated on its top and bottom surfaces;

FIG. 17 is a perspective view of a cylindrical dielectric resonator that has been metal-plated only on its bottom surface;

FIG. 18 is a top view of a filter showing the longer-spaced coupling between two adjacent rectangular resonators without an iris coupler;

FIG. 19 is a top view of a filter showing the longer-spaced coupling between two adjacent cylindrical resonators without an iris coupler;

FIG. 20 is a top view of a filter showing the shorter-spaced coupling between two adjacent rectangular resonators with an iris coupler;

FIG. 21 is a top view of a filter showing the shorter-spaced coupling between two adjacent cylindrical resonators with an iris coupler;

FIG. 22 is a perspective view of a rectangular resonator with partial metallic plating on one of its lateral sides;

FIG. 23 is a perspective view of a cylindrical resonator with partial metallic plating on its cylindrical surface;

FIG. 24 is a top view of a filter showing rectangular and cylindrical resonators adjacent to one another;

FIG. 25 is a top view of a filter showing two similar rectangular resonators positioned 90° from one another;

FIG. 26 is a graph showing the measured insertion loss and return loss responses of a reduced-size filter constructed in accordance with the present invention;

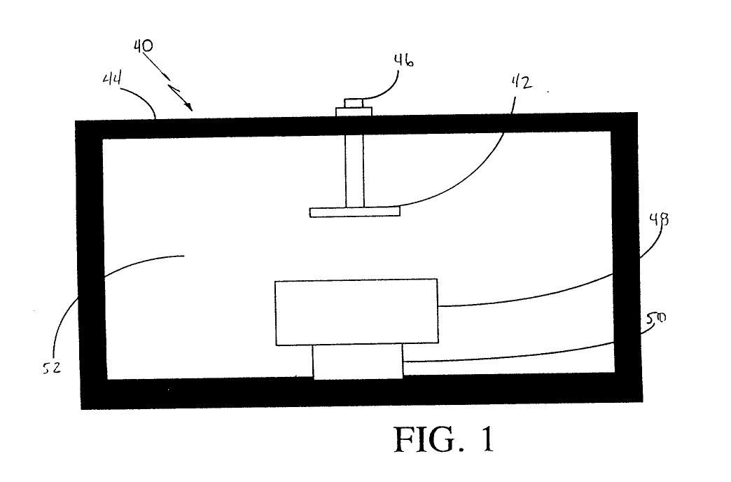

### DETAILED DESCRIPTION OF THE INVENTION

Generally, the present invention provides a tunable dielectric resonator filter operating in a LSE_{10δ} mode. The filter of the present invention is substantially reduced in size and weight when compared to prior art TE_{01δ} filters. Further, it is much easier to tune than prior art dielectric resonator filters, while still satisfying the desired requirements of low insertion loss, good out-of-band rejection performance, relatively large unloaded Qs, high-temperature stability, and ease of manufacturing and mounting.

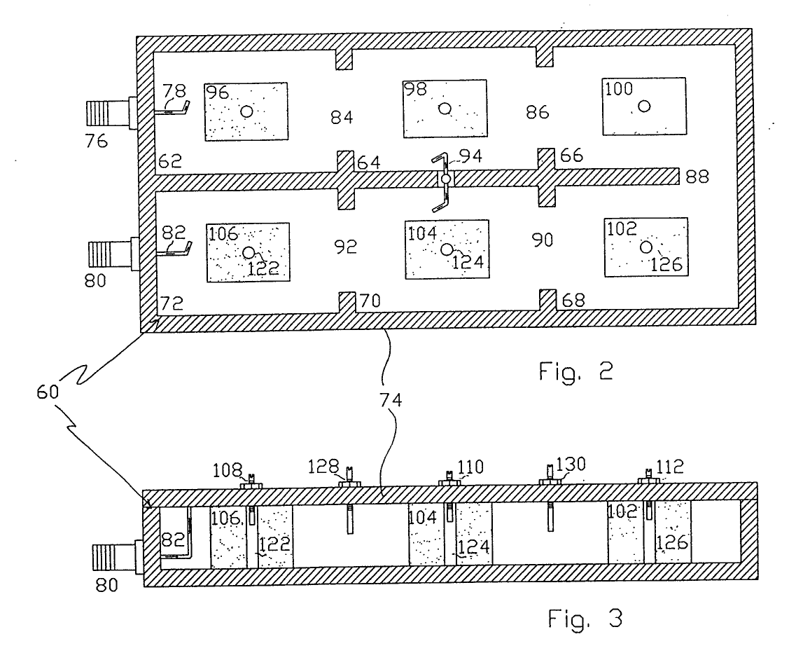

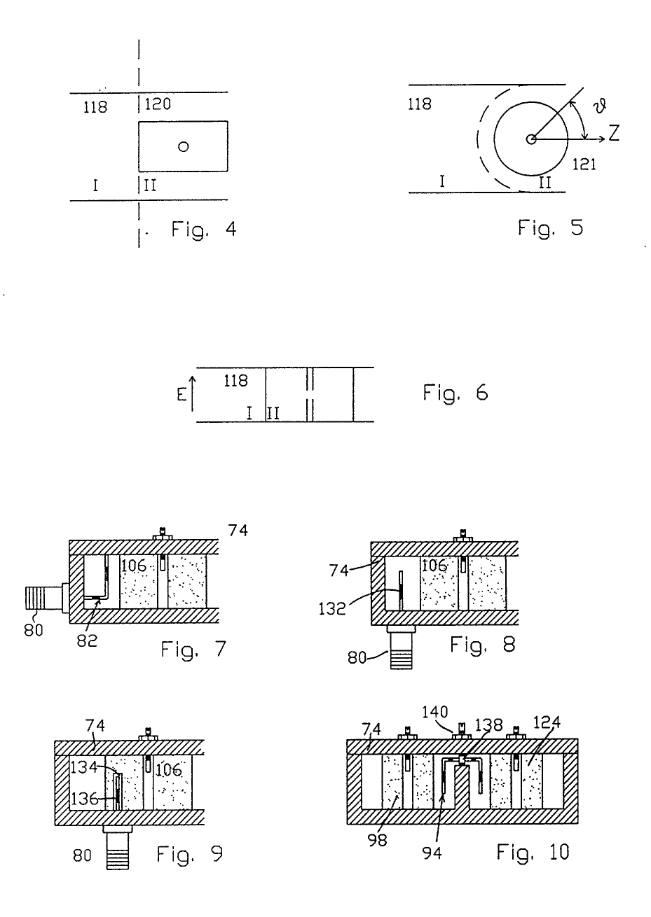

Referring now to FIG. 2 and FIG. 3, there is shown a top view and a cross-sectional view of a six-pole, dielectric resonator filter 60 according to one aspect of the present invention, including six resonant cavities 62, 64, 66, 68, 70 and 72 housed within the metallic walls of a rectangular waveguide structure 74. External coupling of the filter is performed by the coupling devices 76, 78 and 80,82, whereas internal coupling between cavities is performed by the irises 84, 86, 88, 90, and 92 and by the cross coupler 94. Rectangular-shaped dielectric resonators 96, 98, 100, 102, 104 and 106, having a high dielectric constant and high intrinsic Q, are positioned centrally within their respective cavities and flush with the top and bottom walls of the metallic structure 74, as shown in FIG. 3. Substantially central to each dielectric resonator and in the same direction as the electric field (y-axis) is an opening that penetrates the entire resonator, allowing for the insertion of metallic or dielectric tuning screws (or rods) 108, 110 and 112.

Noted that no relative dimensional information should be inferred from these figures, that a smaller or greater number of cavities may be used according to the frequency selectivity requirements of the filter and according to the teachings of the present disclosure, and that alternative forms or shapes of the dielectric resonator, such as puck-shaped disks, may be used. Considering now the structural configuration of the preferred embodiment of FIG. 2, the present invention will be described by way of the electromagnetic signal that propagates through the cavities and by showing how certain characteristics of the derived equations allow for a wide range of trade-off possibilities between the Q factor and the structural dimension.

Due to the geometry of the metallic waveguide structure 74 and the orientation of the coupling probe 82 of FIG. 3, the signal propagating in the unloaded section of the cavity (as shown at 118 of FIGS. 4, 5 and 6), operates in the standard TE₀₁ mode. With the common factor e^{jwt} removed, the components of the electromagnetic field of the signal are given by the super-positioning of incoming and reflected TEₙₒ modes as follows:

$${E}_{y}^{I} = {\sum }_{n} {F}_{n}^{I} {φ}_{n} {ⅇ}^{- {γ}_{n} z} + {\sum }_{n} {B}_{n}^{I} {φ}_{n} {ⅇ}^{{γ}_{n} z}$$

$${H}_{x}^{I} = \frac{j}{{ωμ}_{0}} [ {\sum }_{n} {F}_{n}^{I} {γ}_{n} {φ}_{n} {ⅇ}^{- {γ}_{n} z} - {\sum }_{n} {B}_{n}^{I} {γ}_{n} {φ}_{n} {ⅇ}^{{γ}_{n} z} ]$$

$${H}_{z}^{I} = \frac{j}{{ωμ}_{0}} [ {\sum }_{n} {F}_{n}^{I} {φ}_{n}^{′} {ⅇ}^{- {γ}_{n} z} + {\sum }_{n} {B}_{n}^{I} {φ}_{n}^{′} {ⅇ}^{{γ}_{n} z} ]$$

$$where$$

$${γ}_{n} = \sqrt{{( \frac{n π}{a} )}^{2} - {ω}^{2} {μ}_{0} {ϵ}_{0}} , \\ {φ}_{n} = cos ( \frac{n π}{a} x ) and {φ}_{n}^{′} = \frac{\partial {φ}_{n}}{\partial x}$$

However, as the signal propagates through the loaded section of the cavity, the components of the electromagnetic field are altered due to the super-positioning of the incoming and reflected LSEₘₒ modes. In the section loaded with a rectangular dielectric resonator (as shown at section 120 of FIG. 4), the components of the electromagnetic field are given by the following equations:

$${E}_{y}^{II} = {\sum }_{m} {F}_{m}^{II} {ψ}_{m} {ⅇ}^{- {Γ}_{m} z} + {\sum }_{m} {B}_{m}^{II} {ψ}_{m} {ⅇ}^{{Γ}_{m} z}$$

$${H}_{x}^{II} = \frac{j}{{ωμ}_{0}} [ {\sum }_{m} {F}_{m}^{II} {Γ}_{m} {φ}_{m} {ⅇ}^{- {Γ}_{m} z} - {\sum }_{m} {B}_{m}^{II} {γ}_{m} {ψ}_{m} {ⅇ}^{{Γ}_{m} z} ]$$

$${H}_{z}^{II} = \frac{j}{{ωμ}_{0}} [ {\sum }_{m} {F}_{m}^{II} {ψ}_{m}^{′} {ⅇ}^{- {Γ}_{m} z} - {\sum }_{m} {B}_{m}^{II} {ψ}_{m}^{′} {ⅇ}^{{Γ}_{m} z} ]$$

$$where$$

$${ψ}_{m}^{′} = \frac{\partial {ψ}_{m}}{\partial x}$$

$$\begin{matrix}{ψ}_{m} = sin [ {χ}_{1 m} ( \frac{a - d}{2} ) ] cos ( {χ}_{2 m} x ) & for x < \frac{d}{2} \\ {ψ}_{m} = cos [ {χ}_{2 m} ( \frac{d}{2} ) ] sin [ {χ}_{1 m} ( \frac{a}{2} - x ) ] & for x > \frac{d}{2}\end{matrix}$$

Similarly, in a section loaded with a cylindrical dielectric resonator (as shown at 121 of FIG. 5) the components of the electromagnetic field are given by the following equations:

$${E}_{y}^{II} = {\sum }_{m} {F}_{m}^{II} {Z}_{m} ( kr ) cos ( m θ )$$

$${H}_{x}^{II} = \frac{- j}{{ωμ}_{0}} {\sum }_{m} \frac{n}{r} {F}_{m}^{II} {Z}_{m} ( kr ) sin ( m θ )$$

$${H}_{z}^{II} = \frac{- j}{{ωμ}_{0}} {\sum }_{m} {F}_{m}^{II} {kZ}_{m}^{′} ( kr ) cos ( m θ )$$

where

Zₘ(kr)=fₘJₘ(kr)+Yₘ(kr)

is a linear combination of Bessel and Neumann functions of the order n.

In the second and third sets of the above equations (for the loaded sections), the values of the constants X₁ₘ, X₂ₘ, γₘ and Fₘ are generally obtained by satisfying the continuity conditions of the field on the air/dielectric interfaces and the boundary conditions of the lateral conductor walls. While these parameters vary according to the cavity width, the permitivity of the loaded section, and the dielectric resonator width, they do not depend on the resonator height. It follows therefore that, due to the uniformity of the electric field in the y axis (as shown in FIG. 6), the performance response of the filter regarding the central frequency, bandwidth, and return loss is not affected by changing the height of the filter. Thus, the structural configuration of the present invention (FIG. 2) allows for a wide range of trade-off selections between the Q factor and the filter dimension, and it can be shown that, while remaining well within the imposed selectivity limits, a nominal drop in the Q factor can result in an appreciable reduction in resonator size. This characteristic feature of height independence along the y-axis of tunable dielectric resonators is unique to the present invention.

Considering again the structural configuration of the presently preferred embodiment of the present invention (FIG. 2), it can be seen that the resulting uniformity of the electrical field along the y-axis allows for holes 122, 124 and 126 to be bored parallel to the y-axis and substantially central to, and within, the dielectric resonators. Said holes allow for the insertion of conductive or dielectric screws (or rods) 108, 110 and 112. Upward or downward adjustment of these tuning devices causes perturbation of the electric field distribution E_{y}^{II} of the mode propagating within the respective resonators which, in turn, allows for an appreciable shift in frequency and good tuning of the filter. This internal method for tuning the dielectric resonator is unique to this invention.

Additional tuning of the filter is also made possible under the preferred embodiment as shown in FIG. 3. The tuning devices 128 and 130 are positioned centrally between adjacent dielectric resonators. Upward or downward adjustment of these tuning devices causes perturbation of the electromagnetic field distribution in the TEₙ₀ mode propagating between the resonators which, in turn, allows for tuning of the filter.

In the preferred embodiment of the present invention the input and output coupling, shown in the unloaded sections 62 and 72 of FIG. 2 and FIG. 3, are performed by a shorted rod 78 or 82 as shown in FIG. 7, or by an open rod 132 as shown in FIG. 8. Since this coupling occurs below the cut-off region of the waveguide section, it has less coupling efficiency. This coupling method is better suited for narrow band filter applications.

However, in accordance with another aspect of the present invention, a stronger coupling is made possible for wider band filter applications by inserting the coupling rod 134 through a hole 136 within the dielectric resonator, as shown in FIG. 9. This coupling method is much more efficient than those shown in FIG. 7 and FIG. 8 because the coupling rod 134 is positioned substantially within the concentrated portion of the electrical field.

In yet another embodiment of the present invention, a dual probe 94 is inserted between two non-adjacent dielectric resonators, as shown in FIG. 10. Due to the available space between the dielectric resonator and the lateral wall of the filter, the insertion of a probe within said open space allows for negative cross-coupling between the two non-adjacent resonators. To avoid shorting, the probe 94 is isolated by the dielectric material 138. Additionally, the resonator cross-coupling can be made tunable by connecting the probe 94 to a tuning screw 140, as shown in FIG. 10. Upward or downward adjustment of the tuning screw causes a change in probe position between the two non-adjacent resonators, which, in turn, alters the cross-coupling.

Alternatively, positive cross-coupling between the two non-adjacent dielectric resonators can be achieved by simply opening a small iris in the lateral wall facing the two non-adjacent resonators.

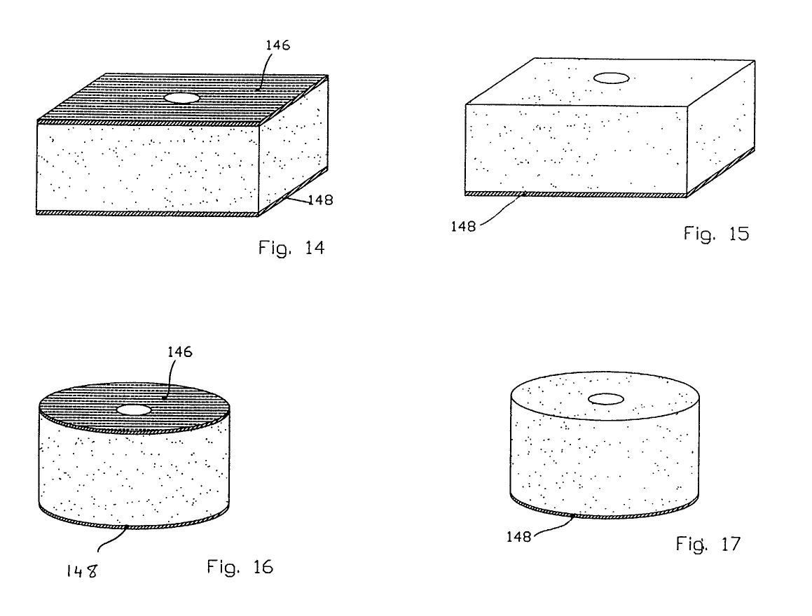

In the presently preferred embodiment of the present invention, the top and bottom of the resonators are in perfect contact with the top and bottom walls of the waveguide structure 74, as shown in FIG. 11. The key advantages of this aspect of the invention are that (a) it avoids propagation of spurious hybrid modes within the filter, (b) it permits reduction in filter size (height independence), and (c) it provides for good thermal conductivity. To achieve a good contact between the resonator and the waveguide walls, the top and bottom of the resonator are plated with a conductive material such as silver or copper or other metallic material, as shown by the metal strips 146 and 148 of FIG. 14 and FIG. 16.

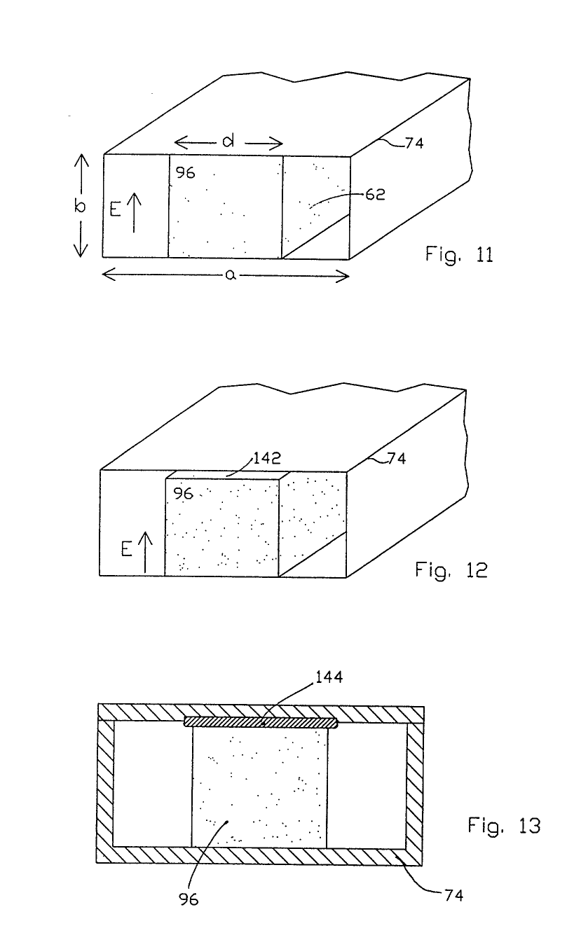

The disadvantage of the tight-fitting configuration of FIG. 11 is that it requires high machining accuracy. To reduce this constraint in topology, an alternative embodiment of the present invention is proposed by introducing a small air gap 142 between the top of the dielectric resonator and the top wall of the waveguide structure 74, as shown in FIG. 12. For a small gap, the equations given above remain basically unaltered if the permitivity is changed by the effective corrective value, and the propagated mode in the loaded section merely changes from a pure LSE mode to a quasi LSE mode. Thus, for the same frequency application, the drawback resulting from this alternative embodiment is a slight increase in the width of the dielectric resonator and the introduction of a small amount of hybrid mode propagation. However, in accordance with a further aspect of the present invention, this drawback can be rectified by filling the air gap 142 with an expandable conductive slab 144, as shown in FIG. 13.

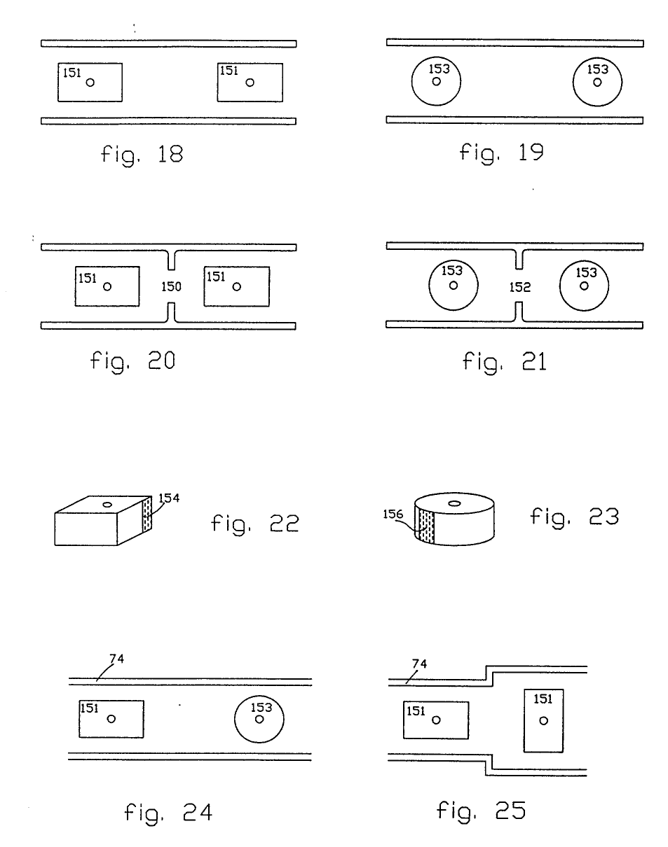

In the presently preferred embodiment of the present invention, the coupling distance between adjacent dielectric resonators can be reduced by the classic prior art method of inserting irises 150 or 152 between rectangular dielectric resonators 151 or cylindrical dielectric resonators 153, as shown in FIG. 20 and FIG. 21. FIGS. 18 and 19 show respective dielectric resonators 151 and 153 without coupling irises. In single-mode filter designs, such a coupling method is required in order to reduce the otherwise wide spacing between adjacent resonators. In yet another aspect of the present invention, it is proposed to reduce the coupling distance between resonators even further by partially plating one lateral face 154 or 156 of the dielectric block with silver, copper, or other metallic material, as shown in FIG. 22 and FIG. 23.

In accordance with yet another aspect of the present invention, it is proposed to use different resonator shapes 151 and 153 or to rotate adjacent resonators 900 from one another, as shown in FIG. 24 and FIG. 25. Depending on the permitivity, dimension, and/or shape of the dielectric resonator, the second mode LSE₂₀₁ can vary between 1.2 and 2.5 times the “central frequency” of the filter. Therefore, by changing the configuration of the resonators as shown in FIG. 24 or FIG. 25, the propagation of this mode can be substantially reduced.

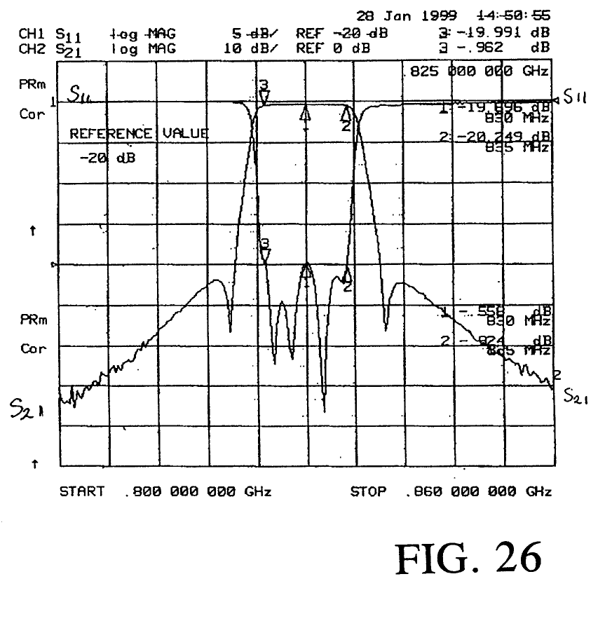

FIG. 26 shows the measured frequency response of a reduced-size filter constructed in accordance with the preferred embodiment of the present invention (FIG. 2). The two s-parameter curves illustrate the excellent performance of the filter in comparison with the larger-sized comb-line or cylindrical-puck dielectric filters of the prior art.

As will be understood by those of skill in the art, the present invention provides the ability to tune a dielectric resonator filter operating in a LSE_{10δ} mode by the simple expedient of tuning screws or rods. The present invention can provide either positive or negative tunable cross-coupling between at least two non-adjacent dielectric resonators in a rectangular waveguide filter. Ideally, the dielectric resonators of the present invention are flush with the upper and lower walls of the metallic waveguide housing. However, by removing the metal from one of the resonator's surface and introducing a small air gap between the top of the dielectric resonator and the top wall of the waveguide structure, the manufacturing and mounting process can be simplified without compromising performance. Further, the coupling distance between adjacent dielectric resonators can be significantly reduced by partially plating one adjacent face of the dielectric block with conductive metallic material. Equally, enhanced performance can be achieved by using different resonator shapes or rotating adjacent resonators 90° from one another in order to reduce the propagation of spurious hybrid modes.

The above-described embodiments of the invention are intended to be examples of the present invention. Alterations, modifications and variations may be effected in the particular embodiments by those skilled in the art, without departing from the scope of the invention which is defined solely by the claims appended hereto.

What is claimed is:

1. A tunable dielectric resonator filter, comprising:
an electrically conductive housing defining a cavity;
a dielectric resonator disposed in the cavity;
a tuning aperture, in the resonator, substantially parallel to a direction of an electric field excited within the resonator; and
a tuning device received within the tuning aperture, the depth of penetration within the resonator of which determines a frequency response of the resonator.

2. The tunable dielectric resonator filter according to claim 1, further including a coupling probe.

3. The tunable dielectric resonator filter according to claim 2, wherein the coupling probe excites the cavity in a TE mode.

4. The tunable dielectric resonator filter according to claim 2, wherein the coupling probe is disposed in a coupling aperture provided in the resonator.

5. The tunable dielectric resonator filter according to claim 1, wherein the resonator is a rectangular prism.

6. The tunable dielectric resonator filter according to claim 1, wherein the resonator is a circular prism.

7. The tunable dielectric resonator filter according to claim 1, wherein top and bottom surfaces of the resonator are substantially flush to respective interior surfaces of the housing.

8. The tunable dielectric resonator filter according to claim 7, wherein the resonator is excited in an LSE mode.

9. The tunable dielectric resonator filter according to claim 8, wherein the resonator is provided with an electrically conductive coating.

10. The tunable dielectric resonator filter according to claim 9, wherein the coating is provided on the top and bottom surfaces.

11. The tunable dielectric resonator filter according to claim 9, wherein the coating is provided on a side surface of the resonator.

12. The tunable dielectric resonator filter according to claim 7, wherein the tuning aperture is substantially parallel to an electric field excited within the resonator.

13. The tunable dielectric resonator filter according to claim 1, wherein the tuning device is a rod.

14. The tunable dielectric resonator filter according to claim 1, wherein the tuning device is a screw.

15. A bandpass filter, comprising a series of dielectric resonator filters coupled together, each of the dielectric filters having an electrically conductive housing defining a cavity, a dielectric resonator disposed in the cavity, a tuning aperture, in the resonator, substantially parallel to a direction of an electric field excited within the resonator, and a tuning device received within the tuning aperture, the depth of penetration within the resonator of which determines a frequency response of the resonator.

16. The bandpass filter according to claim 15, wherein the dielectric resonator filters are coupled by irises.

17. The bandpass filter according to claim 15, wherein the dielectric resonator filters are cross-coupled.

18. The bandpass filter according to claim 15, further including cavity tuning devices.

19. An oscillator comprising a dielectric resonator filter coupled to an oscillating element, the dielectric resonator filter having an electrically conductive housing defining a cavity, a dielectric resonator disposed in the cavity, a tuning aperture, in the resonator, substantially parallel to a direction of an electric field excited within the resonator, and a tuning device received within the tuning aperture, the depth of penetration within the resonator of which determines a frequency response of the resonator

20. A tunable bandpass filter, comprising:
an electrically conductive housing defining a cavity;
an input and an output for coupling a signal to and from the cavity, respectively;
a plurality of dielectric resonators disposed in the cavity, each resonator having a tuning aperture substantially parallel to a direction of an electric field excited within the resonator by the signal, and a tuning device received within the tuning aperture, the depth of penetration within the resonator of which determines a frequency selectivity of the resonator.
